(19) United States
(12) Patent Application Publication
(10) Pub. No.: US 2005/0111021 A1
(43) Pub. Date: May 26, 2005

(54) Methods and apparatus for determining print progress

(75) Inventors: Stephen R. Payne, Cortland, NY (US); Donald E. Brooks, Ithaca, NY (US)

Correspondence Address: Lipsitz & McAllister, LLC, 755 MAIN STREET, MONROE, CT, 06468, US

(73) Assignee: TransAct Technologies Incorporated, Wallingford, CT (US)

(21) Appl. No.: 10/826,832

(22) Filed: Apr. 16, 2004

Related U.S. Application Data
(60) Provisional application No. 60/519,521, filed on Nov. 12, 2003.

(51) Int. Cl. G06F 3/12; G06F 15/00; G06K 15/06; G06F 11/30

(52) U.S. Cl. 358/1.12; 358/1.15; 358/1.14; 710/19

(57) ABSTRACT

Methods and apparatus for determining print progress of a document being printed are provided. The print progress of a document is monitored during printing by monitoring means included in the printer. The percentage of the printing which has been completed is then computed in real time based on information received from the monitoring means. The computed percentage may be used to determine the print completion status of each print field of a document having a plurality of print fields. The computed percentage may be reported to a host device associated with the printer. The computed percentage may be stored in non-volatile memory of the printer and/or of the host device so that the computed percentage of completed printing is maintained during a power failure. The computed percentage of printing completed can be recovered from non-volatile memory upon power recovery.

This application claims the benefit of U.S. provisional patent application No. 60/519,521 filed on Nov. 12, 2003, entitled “Smart Printer Including Configurable Ticket Template, Status Updating, Color Conversion, Print Progress Detection, Print Completion Detection, and Paper Low Sensing Features,” which is incorporated herein and made a part hereof by reference.

### BACKGROUND OF THE INVENTION

The present invention relates generally to the field of printing. More specifically, the present invention provides methods and apparatus for determining print progress of a document being printed.

When printing a document, it is desirable to verify that the document has finished printing. This is often done by placing a sensor at the end of the travel of the fully printed document. When the document reaches this sensor, one can reasonably assume that the document was printed. This approach has the disadvantage of not being able to know the printing progress as the document is being printed. This approach only indicates when the printing is finished.

Another prior art approach is to place a sensor just past the printing mechanism. This sensor can detect that the document has exited the printing mechanism. When the document exits the printing mechanism and passes completely through this sensor, one can reasonably assume that the document was printed. This approach has the disadvantage of not being able to know the printing progress as the document is being printed. This approach only determines that the printing has started and that the printing is completed.

A further prior art approach is to monitor the progress of paper movement within the paper advancing/drive mechanism. A disadvantage of such a system that senses paper drive progress is that it does not ensure that paper was actually successfully moved through the printing mechanism. For example, such a system may indicate that a document has been fully printed, despite a paper jam just after the printer drive mechanism that prevents the document from being fully passed through the printing mechanism.

It would therefor be advantageous to provide methods and apparatus that detect print progress of a document being printed. It would be further advantageous to provide a real time indication of the percentage of printing that has been completed. It would be still further advantageous to be able to determine the document status of each print field of a document having a plurality of print fields as the document is being printed. It would also be advantageous if such methods and apparatus were independent of the paper drive mechanism.

The methods and apparatus of the present invention provide the foregoing and other advantages.

### SUMMARY OF THE INVENTION

The present invention provides methods and apparatus for determining print progress of a document being printed. In an example embodiment of the invention, the print progress of a document is monitored during printing by monitoring means. The percentage of the printing which has been completed can then be computed in real time based on information received from the monitoring means, for example by a processor associated with the monitoring means.

The computed percentage may be stored in non-volatile memory of the printer. Further, the computed percentage may be reported to a host device associated with the printer. Once the computed percentage is reported to the host device, it may be stored in non-volatile memory of the host device.

The computed percentage of completed printing may be displayed on a display of the printer and/or a display of the associated host device.

A printing error may be detected if less than 100 percent of the document is printed. If a printing error is detected, the processor may determine whether sufficient information was printed to provide a usable document. The document may comprise virtually any type of document. However, it is particularly valuable to determine whether sufficient information was printed to provide a usable document when the document comprises one of a ticket, a coupon, a voucher, a receipt, or any similar type of document having a monetary or legal value.

In an example embodiment of the invention, the monitoring means may monitor movement of a paper drive mechanism of the printer during printing. In such an embodiment, the monitoring means may be implemented in software or in hardware.

In an alternative example embodiment of the invention, the monitoring means may be independent of a paper drive mechanism of the printer. For example, the monitoring means may comprise a sensing wheel which rides on the document and which is rotated as the document travels along a paper path during the printing. A sensor may then be provided for sensing rotational movement of the sensing wheel. The sensor may comprise an optical sensor. Alternatively, the sensor may comprise a magnetic sensor.

In an alternative embodiment of the invention, the monitoring means may comprise a series of sensors arranged along a paper path which sense the position of the document as the document travels along the paper path during the printing. The sensors which make up the series of sensors may comprise optical sensors. Alternatively, the sensors which make up the series of sensors may comprise mechanically actuated sensors actuated by movement of the document along the paper path.

In a further example embodiment of the invention, the monitoring means may comprise a cam which is rotated by the document as the document travels along a paper path during the printing. A sensor may be provided for sensing rotational movement of the cam. The sensor may comprise an optical sensor. Alternatively, the sensor may comprise a magnetic sensor.

In an additional example embodiment of the invention, the monitoring means may comprise an optical navigation sensor which senses the position of the document as the document travels along a paper path during the printing.

In a further example embodiment of the invention, the document may comprise a plurality of print fields. The processor may determine a print completion status of each of the plurality of print fields based on the computed percentage. The print field completion status may be reported from the printer to a host device. For example, the print field completion status may be reported in real-time during the printing of the document. The print field completion status may be stored in non-volatile memory of the printer and/or non-volatile memory of the host device. The print field completion status may be displayed on at least one of a printer display or a host device display.

A printing error may be detected if less than all of the plurality of print fields are printed. If a printing error is detected, the processor may determine whether a sufficient number of print fields were printed to provide a usable document.

The processor may determine a location and size of each print field and compare the location and size of each print field with the computed percentage to determine the print field completion status for each print field.

In one example embodiment, the plurality of print fields may comprise critical and non-critical fields. In such an embodiment, the processor may determine a location and size of each critical field and compare the location and size of each critical field with the computed percentage to determine the print field completion status for each critical field. A usable document may be created when all critical fields are printed.

The processor may also determine a location and size of each non-critical field and compares the location and size of each non-critical field with the computed percentage to determine the print field completion status for each non-critical field.

Corresponding methods for print progress detection are also provided in accordance with the invention.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the invention;

FIG. 2 shows an example embodiment of a print progress monitoring means in accordance with the present invention;

FIG. 3 shows an alternative example embodiment of a print progress monitoring means in accordance with the present invention;

FIG. 4 shows an alternative example embodiment of a print progress monitoring means in accordance with the present invention;

FIG. 5 shows an alternative example embodiment of a print progress monitoring means in accordance with the present invention;

FIG. 6 shows an example of a document having a plurality of print fields for use in accordance with the invention;

FIG. 7 shows an example of a printed document created in accordance with the print fields of FIG. 6; and

FIG. 8 (FIGS. 8a and 8b) shows a flowchart illustrating an example embodiment of a method for determining print field completion status of a document having a plurality if print fields in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an example embodiment of the invention. It should be understood that various changes may be made in the function and arrangement of elements without departing from the spirit and scope of the invention as set forth in the appended claims.

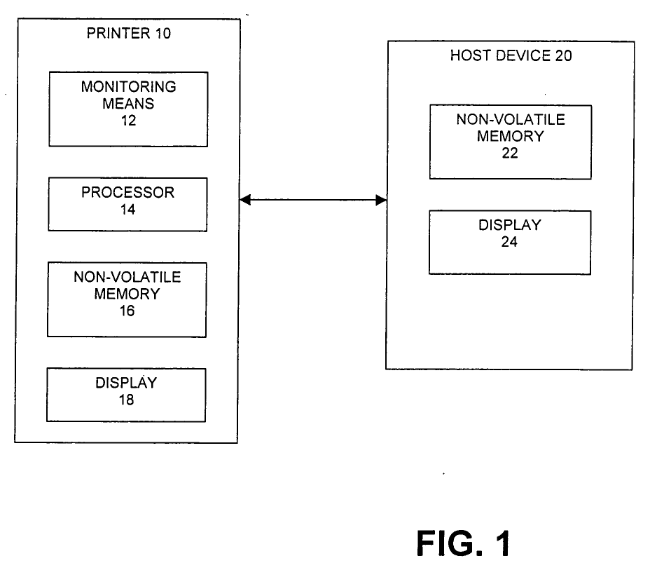

The present invention provides methods and apparatus for determining print progress of a document being printed. In an example embodiment of the invention as shown in FIG. 1, the print progress of a document is monitored during printing by monitoring means 12 included in the printer 10. The percentage of the printing which has been completed can then be computed in real time based on information received from the monitoring means 12, for example by a processor 14 associated with the monitoring means 12.

The computed percentage may be stored in non-volatile memory 16 of the printer 10. Further, the computed percentage may be reported to a host device 20 associated with the printer 10. The computed percentage may be stored in non-volatile memory 22 of the host device 20. By storing the computed percentage of printing completed in non-volatile memory, the percentage of completed printing is maintained even during a power failure of the printer 10 and/or the host device 20. This data retention is useful to determine the completed percentage of printing upon power recovery.

The host device 20 may comprise a personal computer, a cash register, a point of sale terminal, a slot machine, a gaming terminal, a lottery ticket machine, a transportation ticket vending machine, an entertainment ticket vending machine, or the like.

The computed percentage of completed printing may be displayed on a display 18 of the printer 10 and/or on a display 24 of the associated host device 20.

A printing error may be detected if less than 100 percent of the document is printed. For example, printing errors such as paper not feeding and paper jams may be detected if less than 100% of the document is printed. If a printing error is detected, the processor 14 may determine whether sufficient information was printed to provide a usable document. The document may comprise virtually any type of document. However, it is particularly valuable to determine whether sufficient information was printed to provide a usable document when the document comprises one of a ticket, a coupon, a voucher, a receipt, or any similar document having a monetary or legal value.

In an example embodiment of the invention, the monitoring means 12 may monitor movement of a paper drive mechanism of the printer 10 during printing. In such an embodiment, the monitoring means 12 may be implemented in software or in hardware.

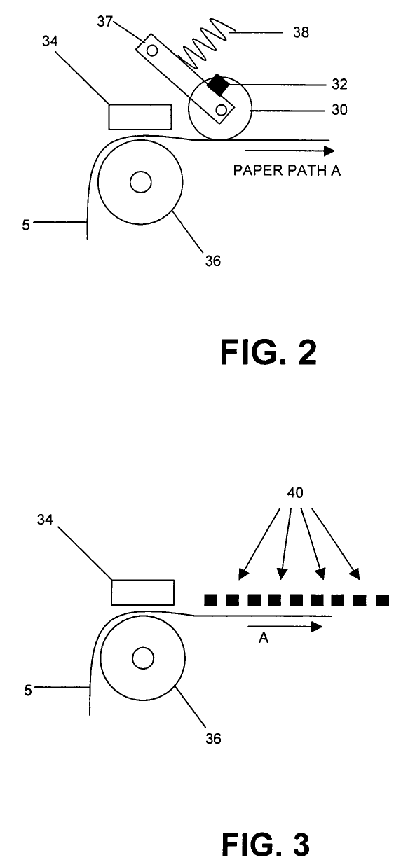

In an alternative example embodiment of the invention as shown in FIG. 2, the monitoring means may comprise a sensing wheel 30 and a sensor 32. The sensing wheel 30 may ride on the document 5 and may be rotated as the document 5 travels along a paper path (shown by arrow A) during the printing by print mechanism 34. A paper drive mechanism 36 drives the document 5 past the print mechanism 34 and along the paper path A. The sensing wheel 30 may be suspended, for example from a housing of the printer, by an arm 37 and tensioned by a spring 38. The sensor 32 senses rotational movement of the sensing wheel 30. The sensor 32 may be mounted on the arm 37 adjacent the sensing wheel 30. The percentage of printing may then be computed based on the amount of rotational movement of the sensing wheel 30 detected by sensor 32. The sensor 32 may comprise an optical sensor. Alternatively, the sensor 32 may comprise a magnetic sensor. Virtually any type of magnetic sensor may be used, including a magnet and Hall effect sensor, a magnet and detection coil, two interacting coils where one coil is electrically excited, or the like.

In an alternative embodiment of the invention as shown in FIG. 3, the monitoring means may comprise a series of sensors 40 arranged along the paper path A which sense the position of the document 5 as the document travels along the paper path A during the printing. The percentage of printing may then be computed based on the distance the document 5 has traveled along the paper path A as sensed by the sensors 40. The sensors that make up the series of sensors 40 may comprise optical sensors. Alternatively, the sensors which make up the series of sensors 40 may comprise mechanically actuated sensors actuated by movement of the document along the paper path.

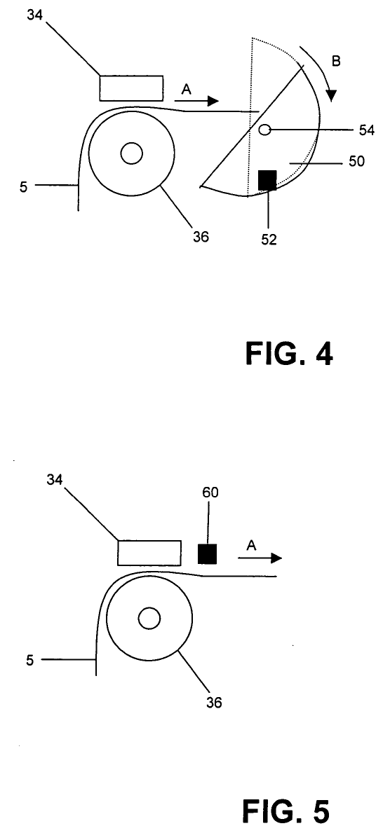

In a further example embodiment of the invention as shown in FIG. 4, the monitoring means may comprise a cam 50 which is rotated by the document 5 as the document 5 travels along a paper path A during printing. The cam may rotate around a pin 54, which may be fixed in the printer housing. A sensor 52 may be provided for sensing rotational movement of the cam 50 (shown by arrow B). The sensor 52 may be affixed adjacent the cam 50 in the printer housing. The percentage of printing may then be computed based on the amount of rotational movement of the cam 50 detected by sensor 52. The sensor 52 may comprise an optical sensor. Alternatively, the sensor 52 may comprise a magnetic sensor. Virtually any type of magnetic sensor may be used, including a magnet and Hall effect sensor, a magnet and detection coil, two interacting coils where one coil is electrically excited, or the like.

In an additional example embodiment of the invention as shown in FIG. 5, the monitoring means may comprise an optical navigation sensor 60 (e.g., a mouse type sensor) which senses the position of the document 5 as the document 5 travels along a paper path A during the printing. In order to properly sense the document 5, the optical navigation sensor 60 must be positioned close enough to the document 5 to sense the paper movement. The percentage of printing may then be computed based on the distance the document 5 has traveled along the paper path A as sensed by the optical navigation sensor 60.

The monitoring means shown in each of FIGS. 2-5 is independent of the paper drive mechanism 36 which drives the document 5 past the print mechanism 34 and along the paper path A. Therefore, the example embodiments of the monitoring means shown in FIGS. 2-5 ensure that the document was actually successfully moved through the printing mechanism.

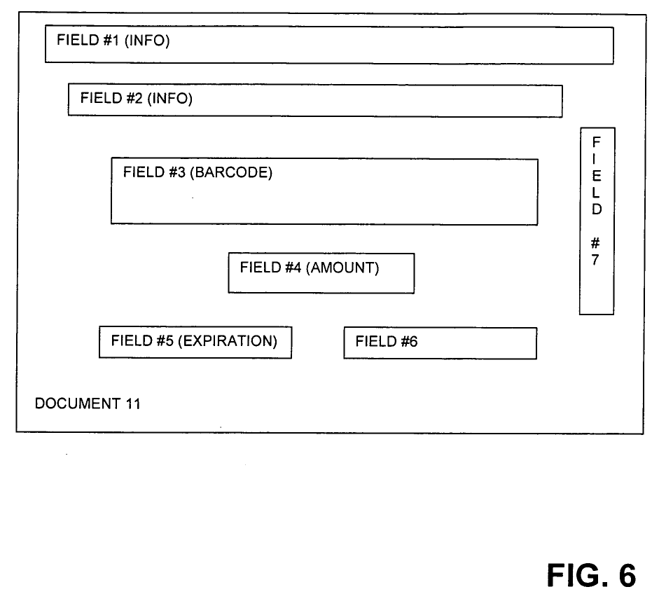

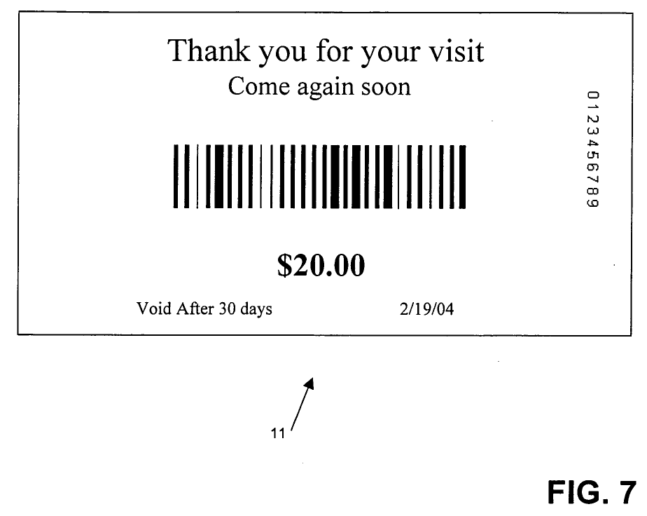

In a further example embodiment of the invention, the document 11 may comprise a plurality of print fields, such as print fields 1-7, as shown in FIG. 6. The processor may determine a print completion status of each of the plurality of print fields 1-7 based on the computed percentage. Once a print field is completed, a print field complete flag may be set for that field. The print field completion status (e.g., indicating which print field complete flags have been set) may be reported from the printer 10 to a host device 20. For example, the print field completion status may be reported in real-time during the printing of the document 11. The print field completion status may be stored in non-volatile memory 16 of the printer 10 and/or non-volatile memory 22 of the host device 20. The print field completion status may be displayed on at least one of a printer display 18 or a host device display 24.

A printing error may be detected if less than all of the plurality of print fields 1-7 are printed. If a printing error is detected, the processor 14 may determine whether a sufficient number of print fields were printed to provide a usable document.

The processor 14 may determine a location and size of each print field 1-7 and compare the location and size of each print field 1-7 with the computed percentage to determine the print field completion status for each print field 1-7.

In one example embodiment, the plurality of print fields 1-7 may comprise critical and non-critical fields. For example, critical fields of document 11 may include field 3 “barcode” and field 4 “Amount”. Other critical fields may include Field 5 “Expiration field” or other fields containing critical information, such as a validation number, date, serial number, or the like. Non-critical fields may include text or information fields such as fields 1 and 2. FIG. 7 shows an example of a printed document 11 created using the print fields shown in FIG. 6. In the example shown in FIG. 7, the document 11 comprises a coupon with a value of $20.00 which expires in 30 days from the printed date of Feb. 19, 2004. The coupon also includes a bar code and serial number, along with the text message “Thank you for your Visit, Come Again Soon”.

The processor 12 may determine a location and size of each critical field and compare the location and size of each critical field with the computed percentage to determine the print field completion status for each critical field. A usable document may be created when all critical fields are printed.

The processor 12 may also determine a location and size of each non-critical field and compares the location and size of each non-critical field with the computed percentage to determine the print field completion status for each non-critical field.

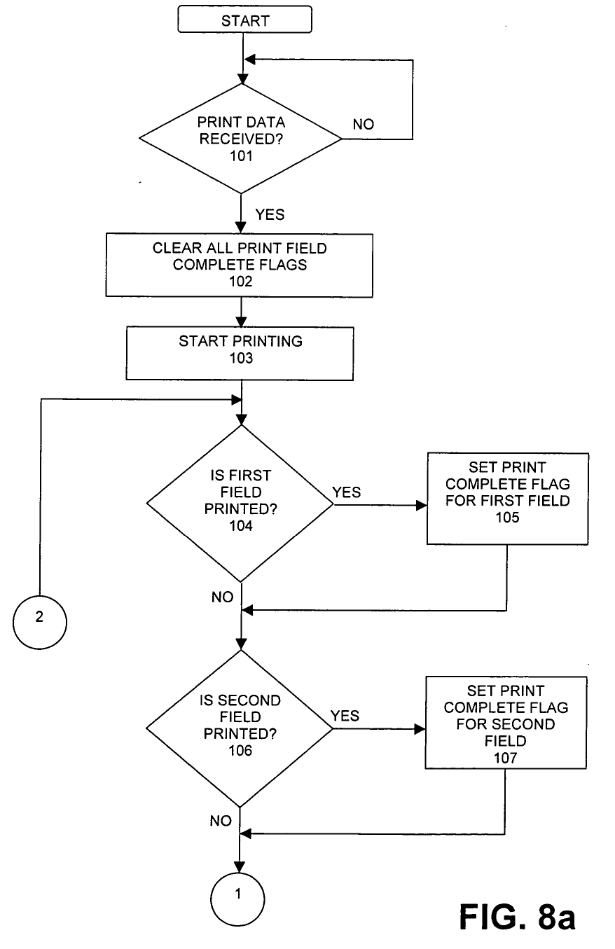

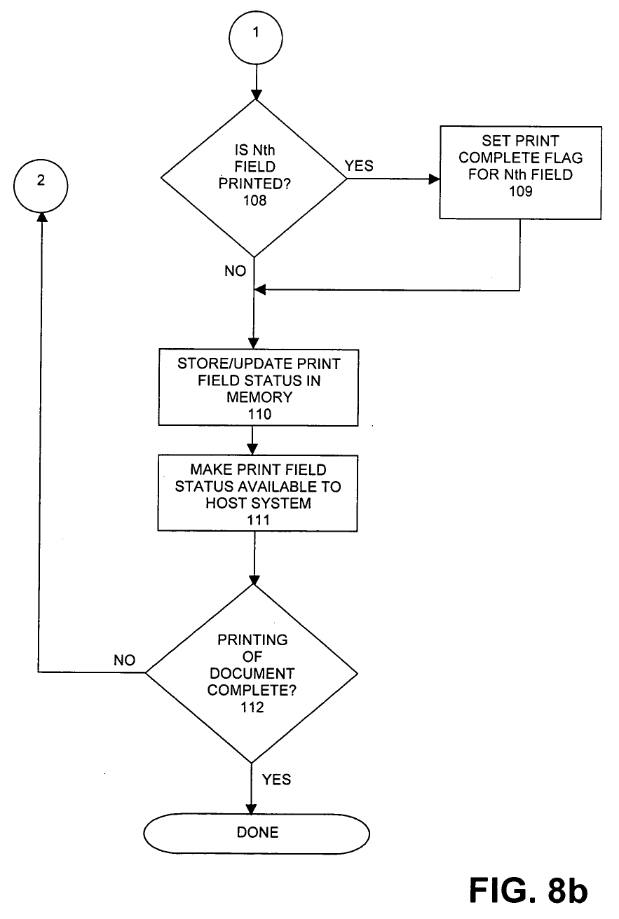

FIG. 8 (FIGS. 8a and 8b) is a flowchart illustrating an example embodiment of a method for determining print field completion status of a document having a plurality (n) of print fields. The printer will first determine whether print data has been received from the host device (101). Once it is determined that print data has been received, the printer will clear all print field complete flags (102) which may have been set during prior printing operations and start printing (103). The printer than monitors the progress of the printing (e.g., via the various monitoring means discussed above) and determines whether a first field has been printed (104). If so, a print complete flag is set for the first field (105) and the printer will then determine if a second print field has been printed (106). If the first field has not been printed, the printer will continue on and determine whether the second field has printed (106). If the second field has printed, a print complete flag will be set for the second field (107). This process will continue for n number of fields. The printer will then determine if the nth field has been printed (108). If so, a print complete flag will be set for field n (109). Whether or not the nth field (i.e., the last field) has been printed, the printer will store or update the print field complete status obtained up to that point (110). This print field completion status may then be made available to the host device (111). The printer will then determine whether the printing has completed (112). If the printing has not completed, the printer will begin re-checking the print field complete status beginning again with the first field (104). This process will continue until the document is finished printing.

Due to the possible variations in size and location of the respective print fields (FIG. 6), a subsequently numbered print field may be finished printing before a prior print field. Therefore, since the print complete status is determined by the percentage of the document that has printed, the printer will check the print complete status of each print field before starting over, rather than wait for each print field to be completed.

It should now be appreciated that the present invention provides advantageous methods and apparatus for determining the print progress of a document being printed.

Although the invention has been described in connection with various illustrated embodiments, numerous modifications and adaptations may be made thereto without departing from the spirit and scope of the invention as set forth in the claims.

1. A method for determining print progress of a document being printed on a printer, comprising:
monitoring print progress of a document during printing; and
computing in real time the percentage of said printing which has been completed based on said monitoring.

2. A method in accordance with claim 1, further comprising:
storing the computed percentage in non-volatile memory.

3. A method in accordance with claim 1, further comprising:
reporting the computed percentage to a host device associated with the printer.

4. A method in accordance with claim 3, further comprising:
storing the computed percentage in non-volatile memory of the host device.

5. A method in accordance with claim 1, further comprising:
displaying the computed percentage on a printer display.

6. A method in accordance with claim 1, further comprising:
displaying the computed percentage on a display of a host device associated with said printer.

7. A method in accordance with claim 1, wherein:
said monitoring comprises monitoring movement of a paper drive mechanism of said printer during printing.

8. A method in accordance with claim 1, wherein:
said monitoring is independent of a paper drive mechanism of said printer.

9. A method in accordance with claim 1, further comprising:
detecting a printing error if less than 100 percent of the document is printed.

10. A method in accordance with claim 9, further comprising:
determining whether sufficient information was printed to provide a usable document.

11. A method in accordance with claim 1, wherein:
said document comprises a ticket, a coupon, a voucher, or a receipt.

12. A method in accordance with claim 1, wherein said document comprises a plurality of print fields, further comprising;
determining print completion status of each of said plurality of print fields based on said computed percentage.

13. A method in accordance with claim 12, further comprising:
reporting said print field completion status from said printer to a host device.

14. A method in accordance with claim 13, wherein:
said reporting comprises real-time reporting during said printing.

15. A method in accordance with claim 12, further comprising:
storing the print field completion status in at least one of non-volatile memory of the printer and non-volatile memory of the host device.

16. A method in accordance with claim 12, further comprising:
displaying the print field completion status on at least one of a printer display or a host device display.

17. A method in accordance with claim 12, further comprising:
detecting a printing error if less than all of said plurality of print fields are printed.

18. A method in accordance with claim 17, further comprising:
determining whether a sufficient number of print fields were printed to provide a usable document.

19. A method in accordance with claim 12, wherein:
said determining step comprises:
determining a location and size of each print field;
comparing the location and size of each print field with the computed percentage to determine the print field completion status for each print field.

20. A method in accordance with claim 12, wherein:
said plurality of print fields comprises critical and non-critical fields; and
said determining step comprises:
determining a location and size of each critical field;
comparing the location and size of each critical field with the computed percentage to determine the print field completion status for each critical field.

21. A method in accordance with claim 20, wherein:
a usable document is created when all critical fields are printed.

22. A method in accordance with claim 20, wherein:
said determining step further comprises:
determining a location and size of each non-critical field;
comparing the location and size of each non-critical field with the computed percentage to determine the print field completion status for each non-critical field.

23. A method in accordance with claim 1, wherein said monitoring comprises:
sensing rotational movement of a sensing wheel which rides on the document and which is rotated as the document travels along a paper path during said printing.

24. A method in accordance with claim 2, wherein:
the rotational movement of the sensing wheel is detected by an optical sensor.

25. A method in accordance with claim 23, wherein;
the rotational movement of the sensing wheel is detected by a magnetic sensor.

26. A method in accordance with claim 1, wherein said monitoring comprises:
sensing the position of the document as the document travels along a paper path during said printing via a series of sensors arranged along the paper path.

27. A method in accordance with claim 26, wherein:
said sensors comprise optical sensors.

28. A method in accordance with claim 26, wherein:
said sensors comprise mechanically actuated sensors actuated by movement of the document along the paper path.

29. A method in accordance with claim 1, wherein said monitoring comprises:
sensing rotational movement of a cam which is rotated by the document as the document travels along a paper path during said printing.

30. A method in accordance with claim 29, wherein:
the rotational movement of the cam is detected by an optical sensor.

31. A method in accordance with claim 29, wherein;
the rotational movement of the cam is detected by a magnetic sensor.

32. A method in accordance with claim 1, wherein said monitoring comprises:
sensing the position of the document as the document travels along a paper path during said printing via an optical navigation sensor.

33. Apparatus for determining print progress of a document being printed on a printer, comprising:
monitoring means for monitoring print progress of a document during printing; and
a processor for computing in real time the percentage of said printing which has been completed based on said monitoring.

34. Apparatus in accordance with claim 33, further comprising:
non-volatile memory for storing the computed percentage.

35. Apparatus in accordance with claim 33, wherein:
the computed percentage is reported to a host device associated with the printer.

36. Apparatus in accordance with claim 35, wherein:
the computed percentage is stored in non-volatile memory of the host device.

37. Apparatus in accordance with claim 33, further comprising:
a display for displaying the computed percentage.

38. Apparatus in accordance with claim 33, wherein:
the computed percentage is displayed on a display of a host device associated with said printer.

39. Apparatus in accordance with claim 33, wherein:
said monitoring means monitors movement of a paper drive mechanism of said printer during printing.

40. Apparatus in accordance with claim 33, wherein:
said monitoring means is independent of a paper drive mechanism of said printer.

41. Apparatus in accordance with claim 33, wherein:
a printing error is detected if less than 100 percent of the document is printed.

42. Apparatus in accordance with claim 41, wherein:
said processor determines whether sufficient information was printed to provide a usable document.

43. Apparatus in accordance with claim 33, wherein:
said document comprises a ticket, a coupon, a voucher, or a receipt.

44. Apparatus in accordance with claim 33, wherein:
said document comprises a plurality of print fields; and
said processor further determines print completion status of each of said plurality of print fields based on said computed percentage.

45. Apparatus in accordance with claim 44, wherein:
said print field completion status is reported from said printer to a host device.

46. Apparatus in accordance with claim 45, wherein:
said print field completion status is reported in real-time during said printing.

47. Apparatus in accordance with claim 44, wherein:
the print field completion status is stored in at least one of non-volatile memory of the printer and non-volatile memory of the host device.

48. Apparatus in accordance with claim 44, wherein:
the print field completion status is displayed on at least one of a printer display or a host device display.

49. Apparatus in accordance with claim 44, wherein:
a printing error is detected if less than all of said plurality of print fields are printed.

50. Apparatus in accordance with claim 49, further comprising:
determining whether a sufficient number of print fields were printed to provide a usable document.

51. Apparatus in accordance with claim 44, wherein:
said processor determines a location and size of each print field and compares the location and size of each print field with the computed percentage to determine the print field completion status for each print field.

52. Apparatus in accordance with claim 44, wherein:
said plurality of print fields comprises critical and non-critical fields; and
said processor determines a location and size of each critical field and compares the location and size of each critical field with the computed percentage to determine the print field completion status for each critical field.

53. A method in accordance with claim 52, wherein:
a usable document is created when all critical fields are printed.

54. A method in accordance with claim 52, wherein:
said processor further determines a location and size of each non-critical field and compares the location and size of each non-critical field with the computed percentage to determine the print field completion status for each non-critical field.

55. Apparatus in accordance with claim 33, wherein said monitoring means comprises:
a sensing wheel which rides on the document and which is rotated as the document travels along a paper path during said printing; and
a sensor for sensing rotational movement of the sensing wheel.

56. Apparatus in accordance with claim 55, wherein:
the sensor comprises an optical sensor.

57. Apparatus in accordance with claim 55, wherein;
the sensor comprises a magnetic sensor.

58. Apparatus in accordance with claim 33, wherein said monitoring means comprises:
a series of sensors arranged along a paper path which sense the position of the document as the document travels along the paper path during said printing.

59. Apparatus in accordance with claim 58, wherein:
said sensors comprise optical sensors.

60. Apparatus in accordance with claim 58, wherein:
said sensors comprise mechanically actuated sensors actuated by movement of the document along the paper path.

61. Apparatus in accordance with claim 33, wherein said monitoring means comprises:
a cam which is rotated by the document as the document travels along a paper path during said printing; and
a sensor for sensing rotational movement of the cam.

62. Apparatus in accordance with claim 61, wherein:
the sensor comprises an optical sensor.

63. Apparatus in accordance with claim 61, wherein;
the sensor comprises a magnetic sensor.

64. Apparatus in accordance with claim 33, wherein said monitoring means comprises:
an optical navigation sensor which senses the position of the document as the document travels along a paper path during said printing.
